(19) United States
(12) Patent Application Publication
(10) Pub. No.: US 2025/0187318 A1
(43) Pub. Date: Jun. 12, 2025

(54) FABRIC ALUMINUM COMPOSITE FILM STRUCTURE

(71) Applicant: SHING FU TEXTILE TECHNOLOGY CO., LTD., Taichung City (TW)

(72) Inventors: YU-CHEN CHENG, Taichung City (TW); WEN-LING LU, Taichung City (TW); WAN-CHIH CHUNG, Taichung City (TW); TZU-MING WU, Taichung City (TW)

(21) Appl. No.: 18/533,208

(22) Filed: Dec. 8, 2023

(51) Int. Cl. B32B 27/12; B32B 5/02; B32B 7/12; B32B 27/36; C09D 5/18; C09D 175/04; C09J 5/06; C09J 175/04

(52) U.S. Cl. CPC B32B 27/12; B32B 5/024; B32B 7/12; B32B 27/36; C09D 5/18; C09D 175/04; C09J 5/06; C09J 175/04; B32B 2250/02; B32B 2255/02; B32B 2255/10; B32B 2255/205; B32B 2255/26; B32B 2255/28; B32B 2260/021; B32B 2260/04; B32B 2262/0284; B32B 2307/3065; B32B 2307/412; B32B 2307/718; B32B 2307/7376; B32B 2307/748; C09J 2475/00

(57) ABSTRACT

A fabric aluminum composite film structure sequentially includes: a flame-retardant fabric layer, which includes a polyester fabric or a polyamide fabric; a flame-retardant coating layer, which includes polyurethane resin and flame retardants; an adhesive layer, which includes a solvent-free adhesive; an aluminum layer; and a transparent polyester layer. In addition, the fabric aluminum composite film structure has sufficient flammability, which is a flame-retardant fabric with weight reduction and good adhesion suitable for reflecting radar waves from a life raft.

### BACKGROUND OF THE INVENTION

### 1. Field of the Invention

The present disclosure relates to a fabric aluminum composite film structure, and in particular to a fabric aluminum composite film structure reflecting radar waves for a life raft.

### 2. Description of the Related Art

In the event of a shipwreck, life rafts placed inside the ship are usually used to evacuate people. In addition, in order to reduce the influence of high temperature on the life raft (e.g., in the event of a fire in the boat), it is desirable to have a flame-retardant fabric layer that makes the life raft flame retardant.

Next, in order to increase the possibility that the life raft will be detected by rescuers, it is hoped that some parts of the life raft can reflect radar waves. Therefore, the flame-retardant fabric layer has been further improved to make it a reflective fabric structure that can reflect radar waves.

A modification of the reflective fabric structure has been proposed. Specifically, as shown in FIG. 1, FIG. 1 is a schematic sectional view of a traditional reflective fabric structure, and a six-layer reflective fabric structure 900 is proposed, which includes: a flame-retardant fabric layer A, a solvent-based adhesive layer B, a first transparent PET layer C, an adhesive layer D, an aluminum layer E and a second transparent PET layer F from top to bottom.

In the above-mentioned reflective fabric structure 900, the flame-retardant fabric layer A can improve flammability; the aluminum layer E can reflect radar waves, thereby increasing the possibility of being detected by rescuers; the second transparent PET layer F can protect the aluminum layer E from chemicals. In addition, the flame-retardant fabric layer A and the aluminum layer E can be combined by the solvent-based adhesive layer B, the first transparent PET layer C and the adhesive layer D.

Therefore, the inventors of the present disclosure find that in the traditional reflective fabric structure, because the flame-retardant fabric layer A has porous characteristics, the surface is rough and not easy to adhere, so it is necessary to use solvent-based adhesive layer B to laminate the flame-retardant fabric layer A with other layers. Then, because the solvent-based adhesive layer B is corrosive and may attack the aluminum layer E, it is necessary to add the first transparent PET layer C between the aluminum layer E and the solvent-based adhesive layer B to prevent the aluminum layer E from being attacked. Next, the first transparent PET layer C is bonded to the aluminum layer E through the adhesive layer D.

However, the inventors of the present disclosure have found that the reflective fabric structure 900 of the prior art has the following drawbacks.

First, the flammability of the reflective fabric structure is insufficient. In the U.S. Federal Acquisition Regulation (FAR) 25.853 Vertical flammability test, an average flame time (Ave Flame Time) in the weft of the above reflective fabric structure is 18 seconds, which is greater than the international standard of 15 seconds. In addition, an average burn length (Ave Burn Length) in the weft is 11 inches, which is greater than the international standard of 8 inches. This may be caused by the fact that the above-mentioned reflective fabric structure is only imparted flammability by a layer of flame-retardant fabric, and the structure is complex (too many layers).

Second, the adhesion strength of the reflective fabric structure is insufficient. In the US Federal Standard (FED STD) 191A Method 5970 test, the warp and weft adhesion strengths of the above reflective fabric structure are respectively 2.90 lbf/inch and 2.13 lbf/inch, which are less than the market demand of 3.0 lbf/inch. This may be caused by the fact that only the adhesive layer is connected (laminated) between the first transparent PET layer, the adhesive layer, and the aluminum layer, resulting in a low overall adhesion strength.

Third, the weight of the reflective fabric structure is more than the standard amount. In the US Federal Standard (FED STD) 191A Method 5041 test, the overall weight of the above reflective fabric structure is 181 g/m², which is greater than the 159 g/m² required for further weight reduction. This may be caused by the addition of the first transparent PET layer between the aluminum layer and the solvent-based adhesive layer, and the adhesive layer requires a large amount of adhesive, resulting in an overall weight more than the standard amount.

### BRIEF SUMMARY OF THE INVENTION

Therefore, in the technical field of the present disclosure, there is room for further improvement for the fabric aluminum composite film structure with the function of reflecting radar waves.

In order to solve the above problems, an aspect of a fabric aluminum composite film structure of the present disclosure sequentially includes: a flame-retardant fabric layer, which includes a polyester fabric or a polyamide fabric; a flame-retardant coating layer, which includes polyurethane resin and flame retardants; an adhesive layer, which includes a solvent-free adhesive; an aluminum layer; and a transparent polyester layer.

In one embodiment, according to FAR 25.853 Vertical Flammability Test, the average burn lengths of the fabric aluminum composite film structure in the warp and the weft are less than 8 inches, the average flame times of the fabric aluminum composite film structure in the warp and the weft are less than 15 seconds.

In one embodiment, the adhesive layer is coated on the aluminum layer.

In one embodiment, the adhesion strength of the fabric aluminum composite film structure is greater than 3.0 lbf/inch.

In one embodiment, the solvent-free adhesive is a moisture-curing polyurethane reactive adhesive.

In one embodiment, the flame-retardant coating layer includes: polyurethane resin of 66-91 parts by weight; flame retardants of 5-27 parts by weight; a cross-linking agent of 0-7 parts by weight.

In one embodiment, a thickness of the transparent polyester layer is 18-25 μm.

In one embodiment, a weight of the fabric aluminum composite film structure is 130-159 g/m².

In one embodiment, a total weight of the flame-retardant fabric layer and the flame-retardant coating layer is 85-95 g/m².

In one embodiment, a weight of the adhesive layer is 15-30 g/m².

In order to solve the above problem, an aspect of a manufacturing method of a fabric aluminum composite film structure of the present disclosure includes the following steps: laminating an aluminum layer and a transparent polyester layer to form an aluminum composite layer; laminating a flame-retardant fabric layer and a flame-retardant coating layer to form a flame-retardant composite layer; coating an adhesive layer on one side of the aluminum layer in the aluminum composite layer, and then through the adhesive layer, laminating one side of the aluminum layer in the aluminum composite layer with one side of the flame-retardant coating layer of the flame-retardant composite layer to form the fabric aluminum composite film structure; wherein the flame-retardant fabric layer includes a polyester fabric or a polyamide fabric; a flame-retardant coating layer includes polyurethane resin and flame retardants; an adhesive layer includes a solvent-free adhesive.

An aspect of the present disclosure is completed in view of the above-mentioned problem points, and the object is to provide a fabric aluminum composite film structure reflecting radar waves suitable for a life raft.

Specifically, the present disclosure is mainly aimed at improving the connection (lamination) mode between the flame-retardant fabric layer and the aluminum layer in the traditional reflective fabric structure. The inventors of the present disclosure find that by forming a flame-retardant coating layer on the flame-retardant fabric layer, it helps to improve the flammability of the fabric aluminum composite film structure; at the same time, the flame-retardant coating layer is easier to laminate to other layers, such as an adhesive layer, than the flame-retardant fabric layer.

Furthermore, by using an adhesive layer including a solvent-free adhesive, the fabric aluminum composite film structure of the present disclosure can omit the first transparent PET layer in the middle of the structure of the prior art, and improve the adhesion strength, so that the layers are not easy to peel off from each other.

In addition, by the fabric aluminum composite film structure of the present disclosure, the overall weight of the structure can be reduced, and the effect of weight reduction is achieved.

### BRIEF DESCRIPTION OF THE DRAWINGS

FIG. 1 (prior art) is a schematic sectional view of a traditional reflective fabric structure.

FIG. 2 is a schematic sectional view of a fabric aluminum composite film structure according to an embodiment of the present disclosure.

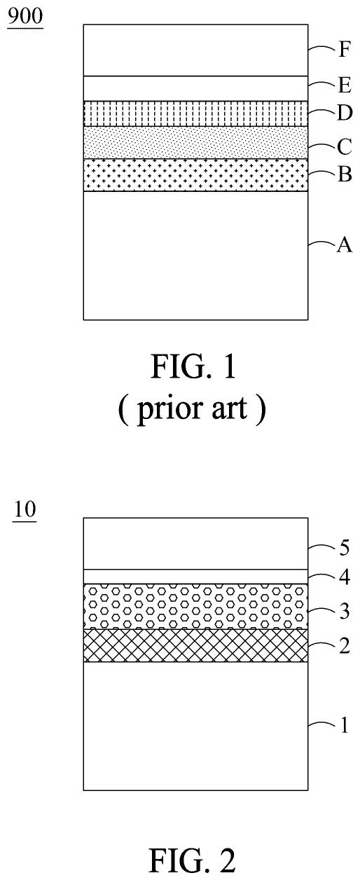

### DETAILED DESCRIPTION OF THE INVENTION

The implementation of the present disclosure is illustrated by the specific embodiments as follows, so one skilled in the art may understand other advantages and effects of the present disclosure by the contents disclosed in the specification.

The present disclosure may also be implemented or applied by other embodiments, and the details in the specification may also be modified and varied based on different views and applications without departing from the spirit of the present disclosure.

Unless otherwise specified herein, the term “A-B” used in the specification and the claims attached includes the meaning of “A or more and B or less”. For example, the term “10-40 wt %” includes the meaning of “10 wt % or more and 40 wt % or less”.

### <Fabric Aluminum Composite Film Structure>

At first, referring to FIG. 2, FIG. 2 is a schematic sectional view of a fabric aluminum composite film structure 10 of an embodiment of the present disclosure. As shown in FIG. 2, the fabric aluminum composite film structure 10 of an embodiment of the present disclosure sequentially includes: a flame-retardant fabric layer 1, a flame-retardant coating layer 2, an adhesive layer 3, an aluminum layer 4 and a transparent polyester layer 5 from bottom to top. In addition, the overall weight (the total weight of each layer) of the fabric aluminum composite film structure 10 is preferable 130-159 g/m². By making the overall weight of the fabric aluminum composite film structure within this range, flammability, adhesion strength, and weight reduction can be taken into account. Next, each layer of fabric aluminum composite film structure 10 of the present disclosure is described in detail.

### <<Flame-Retardant Fabric Layer>>

The flame-retardant fabric layer 1 is a layer in which polyester fabric or polyamide fabric is impregnated in a flame retardant to make it have a flame-retardant effect. In the case of polyester or polyamide fabrics, they are commercially available products, but are not particularly limited. In the case of polyesters, polyethylene terephthalate (PET) may be used, but is not particularly limited. Also, in the case of polyamides, nylon may be used, but is not particularly limited. In addition, as far as flame retardants are concerned, brominated flame retardants, antimony-containing flame retardants and/or phosphorus-containing flame retardants on the market may be used, but are not particularly limited. In addition, from the viewpoint of being able to achieve sufficient flammability and weight reduction, the weight of the flame-retardant fabric layer is preferable 73-78 g/m².

### <<Flame-Retardant Coating Layer>>

The flame-retardant coating layer 2 includes polyurethane resin and flame retardants. Again, flame retardants are as described above; in addition, polyurethane resin can be commercially available products, but are not particularly limited. Next, in a preferred embodiment, the flame-retardant coating layer 2 includes: polyurethane resin of 66-91 parts by weight; flame retardants of 5-27 parts by weight; a cross-linking agent of 0-7 parts by weight. In a preferred embodiment, the flame-retardant coating layer 2 includes: polyurethane resin of 66-91 parts by weight; a brominated flame retardant of 5-13 parts by weight; an antimony-containing flame retardant of 0-7 parts by weight; phosphorus-containing flame retardant of 0-7 parts by weight; a cross-linking agent of 0-7 parts by weight. Among them, isocyanate resins, epoxy resins, and amine-based resins (melamine/formaldehyde resins) may be used for the cross-linking agent, but are not particularly limited.

By using the flame-retardant coating layer 2, in addition to further improving the flammability of the fabric aluminum composite film structure 10, it is no longer necessary to use a solvent-based adhesive layer that may attack the aluminum layer when laminating with other subsequent layers. In this way, combined with the adhesive layer 3 described below, the first transparent PET layer in the middle of the structure of the prior art can be omitted, and the adhesion strength can be improved.

In addition, from the viewpoint of being able to achieve sufficient adhesion and weight reduction, a weight of the flame-retardant coating layer is 12-17 g/m², and a total weight of the flame-retardant coating layer and the flame-retardant fabric layer is 85-95 g/m².

### <<Adhesive Layer>>

The adhesive layer 3 of the present disclosure includes a solvent-free adhesive to reduce the attack of the solvent (such as toluene, butanone, dimethylformamide) to the aluminum layer 4. In addition, as far as solvent-free adhesives are concerned, solvent-free polyurethane adhesives, solvent-free water-based polyurethane and moisture-curing polyurethane reactive adhesives, etc., can be listed, but are not particularly limited, and the solvent-free adhesive can be commercially available products. For example, as a solvent-free adhesive, moisture-curing polyurethane reactive adhesives are preferred from the viewpoint of being able to apply on one side, save weight, and improve adhesion strength (e.g., from Great Eastern Resins Industrial Co. Ltd.).

Next, from the viewpoint of being able to achieve sufficient adhesion and weight reduction, a weight of the adhesive layer is preferable 15-30 g/m², that is, the dry weight of the adhesive amount is 15-30 g/m².

In addition, in one preferred embodiment, the adhesive layer is coated on the aluminum surface of the aluminum layer described later, rather than coated on the flame-retardant coating layer. This is because the aluminum surface of the aluminum layer is smoother than the surface of the flame-retardant coating layer, and has more contacts during bonding, and the adhesive layer coated on the aluminum surface can further strengthen the bonding strength.

### <<Aluminum Layer>>

The aluminum layer 4 is used to reflect radar waves, so that they can be detected by rescuers. In the case of the aluminum layer 4, traditional aluminum layers or commercially available products can be used, but are not particularly limited. In addition, the weight of the aluminum layer is not particularly limited, and in one embodiment, the total weight of the aluminum layer and the transparent polyester layer described later is 30-34 g/m².

### <<Transparent Polyester Layer>>

The transparent polyester layer 5 is used to protect the aluminum layer 4 from chemical attack, and in the case of the transparent polyester layer 5, traditional transparent polyester layers or commercially available products can be used, but are not particularly limited. In addition, a thickness of the transparent polyester layer is preferably 18-25 μm to fully protect the aluminum layer. Further, in one embodiment, the total weight of the transparent polyester layer and the aluminum layer is 30-34 g/m². Furthermore, a combination of transparent polyester layer (e.g., transparent PET layer) and aluminum layer can be purchased from commercially available products.

### <Manufacturing Method of Fabric Aluminum Composite Film Structure>

First, in terms of the manufacturing method of the fabric aluminum composite film structure of the present disclosure, in one embodiment, an aluminum composite layer and a flame-retardant composite layer can be formed respectively by laminating, pasting, and so on. Among them, the aluminum composite layer refers to the aluminum layer plus the transparent polyester layer, and the flame-retardant composite layer refers to the flame-retardant fabric layer plus the flame-retardant coating layer.

Next, the adhesive layer is coated on one side of the aluminum layer in the aluminum composite layer, and then through the adhesive layer, one side of the aluminum layer in the aluminum composite layer is laminated with one side of the flame-retardant coating layer of the flame-retardant composite layer. Whereby, the fabric aluminum composite film structure of the present disclosure can be formed.

### EMBODIMENTS

Although the present disclosure is specifically illustrated by various embodiments and comparative examples as below, the present disclosure is not limited to the embodiments and the comparative examples.

### Embodiment 1

The manufacturing method of the fabric aluminum composite film structure described above is used to obtain the fabric aluminum composite film structure of Embodiment 1. Among them, the flame-retardant fabric layer is made by impregnating PET fabric into a nitrogen phosphorus containing flame retardant (purchased from Taiwan NICCA Chemical Industry Co., Ltd.), and the weight of the flame-retardant fabric layer is 78 g/m². The flame-retardant coating layer is made of 80 parts by weight of polyurethane resin, 9 parts by weight of brominated flame retardant, 6 parts by weight of antimony-containing flame retardant and 5 parts by weight of isocyanate resin cross-linking agent, and the weight of the flame-retardant coating layer is 16 g/m². The adhesive layer uses a moisture-reactive hot-melt adhesive with a weight of 25 g/m². The aluminum layer and the transparent polyester layer are commercially available products that PET film has been coated with aluminum, and have a thickness of 23 μm and a weight of 34 g/m². The overall weight of the fabric aluminum composite film structure of Embodiment 1 is 153 g/m².

Based on the above embodiment, it can be known that in FAR 25.853 Vertical Flammability Test of the fabric aluminum composite film structure of Embodiment 1, an average flame time in the warp is 9 seconds, which is less than 15 seconds, an average drip flame time in the warp is 1 second, which is less than 5 seconds, and an average burn length (Ave Burn Length) in the warp is 7.2 inches, which is less than 8 inches. In addition, an average flame time in the weft is 13 seconds, which is less than 15 seconds, an average drip flame time in the weft is 0 seconds, which is less than 5 seconds, and an average burn length (Ave Burn Length) in the weft is 7.1 inches, which is less than 8 inches. It can be seen that the fabric aluminum composite film structure of the present disclosure has sufficient flammability.

Further, based on the above embodiment, it can be known that an adhesion strength of the fabric aluminum composite film structure of Embodiment 1 is 3.5 lbf/inch, which is greater than 3.0 lbf/inch, that is, the fabric aluminum composite film structure of the present disclosure has sufficient adhesion strength.

Furthermore, based on the above embodiment, it can be known that a weight of the fabric aluminum composite film structure of Embodiment 1 is 153 g/m², which is less than 159 g/m², that is, the fabric aluminum composite film structure of the present disclosure has the characteristics of weight reduction.

The present invention is not limited to the above embodiments, various changes may be made within the scope indicated in the claims, and the embodiments obtained by the appropriate combination of technical means disclosed in different embodiments are also included in the technical scope of the present invention.

What is claimed is:

1. A fabric aluminum composite film structure, sequentially comprising:
a flame-retardant fabric layer, comprising a polyester fabric or a polyamide fabric;
a flame-retardant coating layer, comprising polyurethane resin and flame retardants;
an adhesive layer, comprising a solvent-free adhesive;
an aluminum layer; and
a transparent polyester layer.

2. The fabric aluminum composite film structure according to claim 1, wherein according to FAR 25.853 Vertical Flammability Test, the average burn lengths of the fabric aluminum composite film structure in the warp and the weft are less than 8 inches, the average flame times of the fabric aluminum composite film structure in the warp and the weft are less than 15 seconds.

3. The fabric aluminum composite film structure according to claim 1, wherein the adhesive layer is coated on the aluminum layer.

4. The fabric aluminum composite film structure according to claim 1, wherein an adhesion strength of the fabric aluminum composite film structure is greater than 3.0 lbf/inch.

5. The fabric aluminum composite film structure according to claim 1, wherein the solvent-free adhesive is a moisture-curing polyurethane reactive adhesive.

6. The fabric aluminum composite film structure according to claim 1, wherein the flame-retardant coating layer comprises: polyurethane resin of 66-91 parts by weight; flame retardants of 5-27 parts by weight; a cross-linking agent of 0-7 parts by weight.

7. The fabric aluminum composite film structure according to claim 1, wherein a thickness of the transparent polyester layer is 18-25 μm.

8. The fabric aluminum composite film structure according to claim 1, wherein a weight of the fabric aluminum composite film structure is 130-159 g/m².

9. The fabric aluminum composite film structure according to claim 2, wherein a weight of the fabric aluminum composite film structure is 130-159 g/m².

10. The fabric aluminum composite film structure according to claim 3, wherein a weight of the fabric aluminum composite film structure is 130-159 g/m².

11. The fabric aluminum composite film structure according to claim 4, wherein a weight of the fabric aluminum composite film structure is 130-159 g/m².

12. The fabric aluminum composite film structure according to claim 5, wherein a weight of the fabric aluminum composite film structure is 130-159 g/m².

13. The fabric aluminum composite film structure according to claim 6, wherein a weight of the fabric aluminum composite film structure is 130-159 g/m².

14. The fabric aluminum composite film structure according to claim 7, wherein a weight of the fabric aluminum composite film structure is 130-159 g/m².

15. The fabric aluminum composite film structure according to claim 8, wherein a total weight of the flame-retardant fabric layer and the flame-retardant coating layer is 85-95 g/m².

16. The fabric aluminum composite film structure according to claim 1, wherein a weight of the adhesive layer is 15-30 g/m².

17. The fabric aluminum composite film structure according to claim 8, wherein a weight of the adhesive layer is 15-30 g/m².

18. The fabric aluminum composite film structure according to claim 15, wherein a weight of the adhesive layer is 15-30 g/m².
